(19) United States
(12) Patent Application Publication
(10) Pub. No.: US 2016/0008219 A1
(43) Pub. Date: Jan. 14, 2016

(54) HEAD MASSAGING DEVICE

(71) Applicant: Charles Pollak, Hillside, NJ (US)

(72) Inventor: Charles Pollak, Hillside, NJ (US)

(21) Appl. No.: 14/325,625

(22) Filed: Jul. 8, 2014

(51) Int. Cl. A61H 23/02; A61H 15/00

(52) U.S. Cl. CPC A61H 23/0254; A61H 15/0078; A61H 2201/1215

(57) ABSTRACT

A head massaging device comprising a first band curving over a user's head, where the first band terminates at a front end and a back end; a forehead patch at the front end of the first band, where the forehead patch includes a massager; a neck patch at the back end of the first band, where the neck patch includes at least one massager; a second band bisecting the first band over the user's head, where the second band terminates at a pair of ends; and a pair of patches at each end of the second band, where the pair of patches each include a massager.

### BACKGROUND OF THE INVENTION

1. Field of the Invention

The present invention relates to a head massaging device able to focus therapeutic pressure on predetermined areas of the wearer's head.

2. Description of Related Art

Most individuals deal with some level of stress when reacting to a stimulus. Different stimuli are stressful to different people not always having the same reaction all the time. Things like a late appointment, traffic or even a dress fitting may be stressful to some and not others. As stresses build up, the person may experience emotional and cognitive symptoms like memory loss, worry, moodiness and agitation. Some people even experience physical symptoms like achiness, nausea, indigestion and colds. Whether an external sources or internal annoyance, the person must learn and develop their own personal techniques to handle and reduce their stress. To combat stress some people try relaxation techniques like breathing, exercising or meditation to calm them. Alternatively, some look to external sources for stress relief. These may be massages, therapy or simply talking it out to another individual. For those who prefer massages, the masseuse is able to pinpoint pressure points to relax the body, and they are able to rub away knots formed after exposure to prolonged tension and stress. At home massaging devices are also available to let the person perform their own massage. The devices may range from electric chair massagers, handheld neck massagers, and even small battery powered hand massagers. While all these devices are helpful it is often difficult to find a device able to massage the head. With so many pressure points and nerve endings, the head is an enjoyable place to have a massage. Further, head, scalp and temple rubbing can relieve headaches and migraines. But head massages are often costly to routinely have done, and the devices are difficult to find able to isolate specific areas of the head.

Therefore it would be beneficial in the art to provide a massaging device that massages a user's head. It would also be desirable in the art to provide a head massaging device that presses on specific areas of the head to relieve and eliminate stress.

### SUMMARY OF THE INVENTION

In view of the foregoing disadvantages inherent in the prior art, the general purpose of the present invention is to provide a head massaging device enveloping a user's head, configured to include all of the advantages of the prior art, and to overcome the drawbacks inherent therein.

Accordingly, an object of the present invention is to provide a head massaging device that includes a pair of bisecting bands that crisscross over a user's head. The bands terminate in massagers that are strategically positioned over the temples, forehead and neck.

To achieve the above objects, in an aspect of the present invention, a head massaging device is described comprising a first band curving over a user's head, where the first band terminates at a front end and a back end; a forehead patch at the front end of the first band, where the forehead patch includes a massager; a neck patch at the back end of the first band, where the neck patch includes at least one massager; a second band bisecting the first band over the user's head, where the second band terminates at a pair of ends; and a pair of patches at each end of the second band, where the pair of patches each include a massager.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a head massaging device in accordance with an exemplary embodiment of the present invention.

### DETAILED DESCRIPTION OF THE DRAWINGS

The present invention relates to a head massaging device able to focus therapeutic pressure on predetermined areas of the wearer's head. The present invention provides a head massaging device offering individuals undulating sensations to the head. The head massaging device includes bisecting bands which crisscross over the user's head. At the ends of the bands are massagers that are positioned on the temples, forehead and nape to strategically apply pressure and relieve tension throughout the user's body. The massagers are secured in placed with rubber patches providing tension against the user's skin. The head massaging device offers both undulating movements and rhythmic rotation thus providing complete relaxation and comfort for the user.

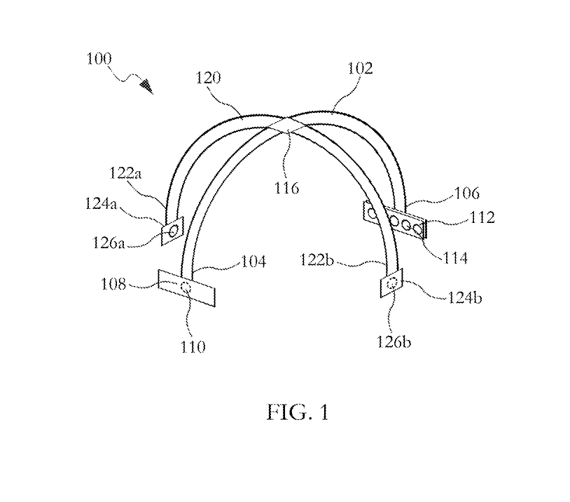

Turning now descriptively to the drawing, FIG. 1 shows a perspective view of a head massaging device 100 in accordance with an exemplary embodiment of the present invention. The head massaging device 100 includes a pair of bisecting bands, a first band 102 and a second band 120. The first band 102 and the second band 120 meet in the middle and curve downward from their intersection to fit comfortably over a user's head. The bands 102, 120 may be adjustable in length and in contour to enable user exchange with the same device.

At a front end 104 of the first band 102 may be a forehead patch 108. Within the forehead patch 108 is a massager 110 that offers a plurality of movements, rotations and vibrations selectable by the user with a controller 116. The forehead patch 108 may extend across the entire forehead, in one particular embodiment the forehead patch 108 may variably extendable in length. At a back end 106 of the first band 102 may be a neck patch 112. The neck patch 112 is preferably positioned at the nape of the neck, about two inches above the first cervical vertebrae, to apply strategic pressure to this sensitive area. As a consequence, the back end 106 of the first band 102 extends to a level consistent with the lower ear lobes of a user so that the massaging sensations are felt in the upper neck area. The neck patch 112 may include at least one massager 114. The neck patch 112 may extend across the back of the user's neck, and may include indentions that embrace the contours of the spine and muscles of the neck for an optimal massaging effect. The neck patch 112 is snug enough to deliver a relaxing sensation without exerting too much pressure on the area. In one particular embodiment, the width of the neck patch 112 may be consistent with the width of the forehead patch 108 and variably extendable in width.

The second band 120 includes a pair of ends 122a, 122b. Each end 122 includes a patch 124a, 124b and each patch 124a, 124b includes a massager 126a, 126b. The massagers 126a, 126b may be preferably positioned over the user's temples. These massagers 126a, 126b may be controlled by the controller 116. The bands 102, 120 may be approximately two inches wide terminating at patches 108, 112, 124a, 124b of approximately the same size.

The controller 116 may select the massage settings for each massager on the head massaging device 100. Additionally, the controller 116 may include a battery pack to power each massager. The controller 116 may be positioned along the first band 102, the second band 120 or at the point where the bands 102, 120 intersect. An individual controller may be positioned within each massager to enable the user to isolate which massager is in use and how the massager is operating.

The bands may be rubber or plastic and may include an internal wire to allow the head massaging device to conform and contour to the user's head thus providing maximum comfort. The patches may be rubber thereby providing friction against the user's skin to keep them in place. Likewise, a cushion may rest between the patches and the user's skin to ensure optimal comfort while wearing the head massaging device. Alternatively, a layer of skin safe adhesive may be placed on the patch to secure the patch and massager to the skin.

The massagers may be positioned internally within the patches, or they may be positioned on the surface of the patch in contact with the user. The massagers may be balls that rotate around each other, slide back and forth, vibrate, and oscillate against the user's head. The massagers may be electrical pulses that stimulate the muscles and nerves on the forehead, neck and temples. The controller enables the user to select between which types of movement the massagers will perform. The head massaging device fits snug yet comfortably for optimal tension and pressure on the head.

The head massaging device fits over the head like a bicycle helmet. The first band and the second band are flexible and provide both a vertical and horizontal component able to fit snugly over the cranium. This enables just enough pressure/tension to allow for a comfortable massage on sensitive areas.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A head massaging device comprising:
a. a first band curving over a user's head, where the first band terminates at a front end and a back end;
b. a forehead patch at the front end of the first band, where the forehead patch includes a massager;
c. a neck patch at the back end of the first band, where the neck patch includes at least one massager;
d. a second band bisecting the first band over the user's head, where the second band terminates at a pair of ends; and
e. a pair of patches at each end of the second band, where the pair of patches each include a massager.

2. The head massaging device according to claim 1, where the head massaging device includes a controller to operate the plurality of massagers.

3. The head massaging device according to claim 2, where the controller includes a battery pack.

4. The head massaging device according to claim 1, where a controller in positioned within each massager.

5. The head massaging device according to claim 1, where the first band and the second band are adjustable in length and contour.

6. The head massaging device according to claim 1, where the first band and the second band are made of rubber with an internal wire.

7. The head massaging device according to claim 1, where the plurality of massagers include a pair of balls.

8. The head massaging device according to claim 7, where the pair of balls rotate around each other, slide back and forth, vibrate and oscillate against the user's head.

9. The head massaging device according to claim 1, where the first band and the second band are two inches wide.

10. The head massaging device according to claim 1, where the front patch, the back patch and the pair of patches are rubber to provide friction against the user's head.
